(19) United States
(12) Patent Application Publication
(10) Pub. No.: US 2026/0186358 A1
(43) Pub. Date: Jul. 2, 2026

(54) Array Substrate, Display Panel, Display Device, and Mask

(71) Applicants: Ordos Yuansheng Optoelectronics Co., Ltd., Ordos, Inner Mongolia (CN); BOE TECHNOLOGY GROUP CO., LTD., Chaoyang District, Beijing (CN)

(72) Inventors: Liang Tian, Beijing (CN); Zhixiang Wang, Beijing (CN); Xinguo Wu, Beijing (CN); Yezhou Fang, Beijing (CN); Zhanhu Meng, Beijing (CN); Kai Li, Beijing (CN); Bo Zhao, Beijing (CN); Hong Liu, Beijing (CN); Guojiang Yu, Beijing (CN); Yang Wang, Beijing (CN); Chunsheng Guo, Beijing (CN); Longlong Chen, Beijing (CN)

(21) Appl. No.: 18/728,908

(22) PCT Filed: Mar. 21, 2023
(86) PCT No.: PCT/CN2023/082826

§ 371 Date: Jul. 15, 2024

(51) Int. Cl. G02F 1/1362

(52) U.S. Cl. CPC G02F 1/136286; G02F 1/136209; G02F 1/13625

(57) ABSTRACT

An array substrate is provided. The array substrate has a display region, a fan-out region, and a bonding region. The array substrate includes a base, a plurality of connecting leads, and a planarization layer. The planarization layer is located on a side of the plurality of connecting leads away from the base, and has a first pattern region located in the fan-out region. The planarization layer includes a plurality of first recessed portions provided in the first pattern region, and an orthographic projection of at least one first recessed portion on the base overlaps with an orthographic projection of at least one connecting lead on the base; and along a direction perpendicular to the base, the first recessed portions and the connecting leads have a distance therebetween.

### CROSS-REFERENCE TO RELATED APPLICATION

This application is the United States national phase of International Patent Application No. PCT/CN2023/082826, filed Mar. 21, 2023, the disclosure of which is hereby incorporated by reference in its entirety.

### BACKGROUND OF THE INVENTION

### Field of the Invention

The present disclosure relates to the field of display technologies, and in particular, to an array substrate, a display panel, a display device, and mask.

### Description of Related Art

Liquid crystal display (LCD) devices have been widely used due to advantages such as low power consumption, suitability for miniaturization, light weight and small thickness. For example, the LCD devices have been used in various fields such as mobile phones, flat panel displays, on-board equipment, televisions, and public displays.

### SUMMARY OF THE INVENTION

In an aspect, an array substrate is provided. The array substrate has a display region, a fan-out region, and a bonding region. The array substrate includes a base, a plurality of connecting leads provided on a side of the base and located in the fan-out region, and a planarization layer. The planarization layer is located on a side of the plurality of connecting leads away from the base, and has a first pattern region located in the fan-out region. The planarization layer includes a plurality of first recessed portions provided in the first pattern region, and an orthographic projection of at least one first recessed portion on the base overlaps with an orthographic projection of at least one connecting lead on the base; and along a direction perpendicular to the base, the first recessed portions and the connecting leads have a distance therebetween.

In some embodiments, a ratio of a depth, along the direction perpendicular to the base, of the first recessed portion to a thickness, along the direction perpendicular to the base, of the planarization layer is in a range of 0.25 to 0.65, inclusive.

In some embodiments, the first recessed portion includes a first bottom wall, and the first bottom wall is proximate to the base; and along the direction perpendicular to the base, a distance between the first bottom wall and the connecting lead is greater than or equal to 1 μm.

In some embodiments, the first recessed portion further includes a first side wall, and a slope of a tangent line of the first side wall has a variation less than or equal to 0.1.

In some embodiments, the planarization layer further includes a connecting portion provided in the first pattern region, and the connecting portion is located between the plurality of first recessed portions and connects the plurality of first recessed portions; and an included angle between a surface of the connecting portion away from the base and the first side wall is in a range of 125° to 160°, inclusive.

In some embodiments, the included angle between the surface of the connecting portion away from the base and the first side wall is in a range of 150° to 155°, inclusive.

In some embodiments, the array substrate further includes a plurality of bonding pins. The plurality of bonding pins are provided in the bonding region, each bonding pin being electrically connected to at least one connecting lead. Along a first direction, a distance between outer boundaries of two first recessed portions furthest away from each other is greater than a distance between outer boundaries of two bonding pins furthest away from each other in the bonding region; and the first direction is parallel to an extension direction of a boundary between the display region and the fan-out region.

In some embodiments, the plurality of first recessed portions are arranged in multiple rows, and the multiple rows of first recessed portions are spaced apart along a second direction; any two adjacent rows of first recessed portions are staggered along a first direction; and the first direction is parallel to an extension direction of a boundary between the display region and the fan-out region, and the second direction is parallel to an arrangement direction of the display region and the fan-out region.

In some embodiments, the planarization layer further includes a trench, and the trench is located in the fan-out region and is further away from the display region than the first pattern region; the array substrate further has a first side edge and a second side edge that are opposite in a first direction, the first direction is parallel to an extension direction of a boundary between the display region and the fan-out region, and the trench extends from the first side edge to the second side edge.

In some embodiments, an orthographic projection of the trench on the base partially overlaps with an orthographic projection of at least one connecting lead on the base; and a ratio of a depth, along the direction perpendicular to the base, of the trench to a thickness, along the direction perpendicular to the base, of the planarization layer is in a range of 0.25 to 0.65, inclusive.

In some embodiments, the trench includes a second bottom wall; and a distance, along the direction perpendicular to the base, between the second bottom wall and the connecting lead is greater than or equal to 1 μm.

In some embodiments, a depth, along the direction perpendicular to the base, of the trench is greater than a depth, along the direction perpendicular to the base, of the first recessed portion.

In some embodiments, a boundary of the first pattern region proximate to the bonding region is a polyline; and the trench extends along an extension direction of the boundary of the first pattern region proximate to the bonding region.

In some embodiments, a distance between the first pattern region and the display region is in a range of 100 μm to 200 μm, inclusive; and/or a distance between the first pattern region and the trench is in a range of 5 μm to 50 μm, inclusive; and/or a distance between the trench and the bonding region is in a range of 5 μm to 50 μm, inclusive.

In some embodiments, the fan-out region includes a first wiring region; a width, in the first wiring region, of the connecting lead is in a range of 1.5 μm to 1.9 μm inclusive; a distance between two adjacent connecting leads is in a range of 1.6 μm to 2.0 μm, inclusive; and the orthographic projection of the first recessed portion on the base overlaps with orthographic projections of at least two connecting leads on the base.

In some embodiments, the planarization layer further includes a plurality of second recessed portions provided in the first pattern region, and orthographic projections of the second recessed portions on the base are non-overlapping with orthographic projections of the connecting leads on the base; and a depth of a second recessed portion is greater than a depth of the first recessed portion.

In some embodiments, a distance between a boundary of the display region proximate to the bonding region and a boundary of the bonding region away from the display region is less than or equal to 2.4 mm.

In some embodiments, the array substrate further includes an alignment film. The alignment film is located on a side of the planarization layer away from the base, and at least partially located in the display region.

In another aspect, a display panel is provided. The display panel includes the array substrate described in any of the above embodiments, a color filter substrate provided opposite the array substrate, and a liquid crystal layer provided between the array substrate and the color filter substrate.

In yet another aspect, a display device is provided. The display device includes the display panel described above, a flexible circuit board, and a driver chip. The flexible circuit board is bonded to the array substrate of the display panel, and at least partially bent to a back side of the array substrate. The driver chip is provided on the array substrate, and located between the flexible circuit board and a trench of the array substrate.

In still another aspect, another display device is provided. The display device includes the display panel described above, a chip-on-film, and a driver chip. The chip-on-film is bonded to the array substrate of the display panel, and at least partially bent to a back side of the array substrate. The driver chip is provided on the chip-on-film, and located on the back side of the array substrate.

In still yet another aspect, a mask is provided. The mask is used for manufacturing the array substrate described in any of the above embodiments. The mask includes a second pattern region. The second pattern region includes a plurality of first opening regions, each first opening region being configured to cause the planarization layer to form a first recessed portion. The first opening region includes a first light-shielding pattern and multiple first through holes spaced apart, and a boundary of the first light-shielding pattern defines the multiple first through holes; and a light transmittance of the first light-shielding pattern is 0%, and light transmittances of the first through holes are 100%.

A shape of each first opening region is a rectangle, and a side length of the first opening region is greater than or equal to 10 μm; and/or a distance between two adjacent first opening regions is greater than or equal to 5 μm; and/or a distance between two adjacent first through holes in each first opening region is in a range of 1.0 μm to 1.5 μm, inclusive; and/or an opening shape of each first through hole is a square, and a side length of the first through hole is in a range of 1.0 μm to 1.5 μm, inclusive.

### BRIEF DESCRIPTION OF THE DRAWINGS

In order to describe technical solutions in the present disclosure more clearly, the accompanying drawings to be used in some embodiments of the present disclosure will be introduced briefly; obviously, the accompanying drawings to be described below are merely accompanying drawings of some embodiments of the present disclosure, and a person of ordinary skill in the art can obtain other accompanying drawings according to those accompanying drawings. In addition, the accompanying drawings to be described below may be regarded as schematic diagrams, and are not limitations on actual sizes of products, actual processes of methods and actual timings of signals involved in the embodiments of the present disclosure.

FIG. 1 is a structural diagram of a display device, in accordance with some embodiments;

FIG. 2 is another structural diagram of a display device, in accordance with some embodiments;

FIG. 3A is a structure diagram illustrating a connection between a driver chip and an array substrate, in accordance with some embodiments;

FIG. 3B is another structure diagram illustrating a connection between a driver chip and an array substrate, in accordance with some embodiments;

FIG. 4 is a structural diagram of an array substrate, in accordance with some embodiments;

FIG. 5 is a sectional view taken along the section line A1-A1 in FIG. 4;

FIG. 6 is a partially enlarged view of the B1 region in FIG. 4;

FIG. 7A is a sectional view taken along the section lines C1-C1 and C2-C2 in FIG. 4;

FIG. 7B is a diagram illustrating surface tension of an alignment liquid on a planarization layer, in accordance with some embodiments;

FIG. 8 is a schematic diagram illustrating the flow of an alignment liquid on a planarization layer, in accordance with some embodiments;

FIG. 9 is a structural diagram of a groove formed on a planarization layer in the related art;

FIG. 10 is another structural diagram of an array substrate, in accordance with some embodiments;

FIG. 11 is a partially enlarged view of the B2 region in FIG. 4;

FIG. 12 is a sectional view taken along the section line E-E in FIG. 11;

FIG. 13 is a sectional view taken along the section lines C3-C3 and C2-C2 in FIG. 4;

FIG. 14 is a structural diagram of a mask, in accordance with some embodiments;

FIG. 15A is a partially enlarged view of the G region in FIG. 14;

FIG. 15B is another partially enlarged view of the G region in FIG. 14; and

FIG. 16 is a partially enlarged view of the H region in FIG. 14.

### DESCRIPTION OF THE INVENTION

The technical solutions in some embodiments of the present disclosure will be described clearly and completely with reference to the accompanying drawings. Obviously, the described embodiments are merely some but not all of embodiments of the present disclosure. All other embodiments obtained by a person of ordinary skill in the art on the basis of the embodiments of the present disclosure shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the quantity of indicated technical features. Thus, the features defined with “first” and “second” may explicitly or implicitly include one or more of the features. In the description of the embodiments of the present disclosure, the term “a plurality of (or multiple)” means two or more unless otherwise specified.

Some embodiments may be described using “connection” and its derivatives may be used. The term “connection” should be understood in a broad sense. For example, “connection” can be a fixed connection, a detachable connection, or an integrated connection; it can be a direct connection or an indirect connection through an intermediate medium.

“A and/or B” includes the following three combinations: only A, only B, and a combination of A and B.

The “applicable to” or “configured to” used herein means an open and inclusive expression, which does not exclude devices that are applicable to or configured to perform additional tasks or steps.

In addition, the phrase “based on” used is meant to be open and inclusive, since a process, step, calculation, or other action that is “based on” one or more of the stated conditions or values may, in practice, be based on additional conditions or values exceeding those stated.

The terms such as “about”, “substantially” or “approximately” as used herein each include a stated value and an average value within an acceptable range of deviation of a particular value determined by a person of ordinary skill in the art, considering measurement in question and errors associated with measurement of a particular quantity (i.e., limitations of a measurement system).

The terms such as “parallel”, “perpendicular”, and “equal” as used herein each include a stated case and a case similar to the stated case within an acceptable range of deviation determined by a person of ordinary skill in the art, considering measurement in question and errors associated with measurement of a particular quantity (i.e., limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, that a difference between two equals is less than or equal to 5% of either of the two equals.

It will be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the accompanying drawings, thicknesses of layers and areas of regions are enlarged for clarity. Variations in shape relative to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown in a rectangular shape generally has a feature of being curved. Therefore, the regions shown in the accompanying drawings are schematic in nature, and their shapes are not intended to show actual shapes of the regions in a device, and are not intended to limit the scope of the exemplary embodiments.

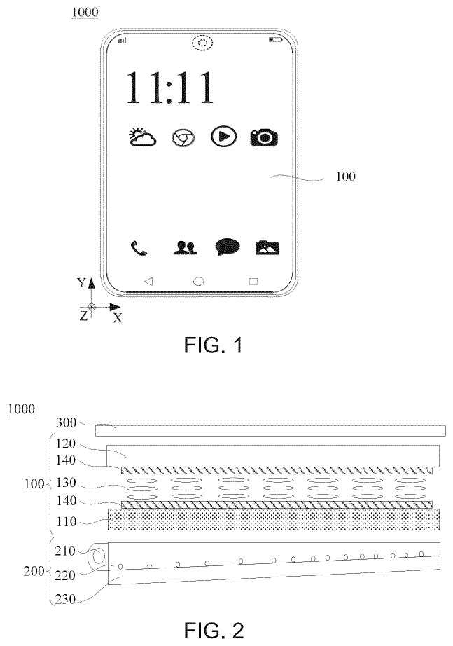

Some embodiments of the present disclosure provide a display device 1000, referring to FIG. 1, the display device 1000 may be any device that can display an image whether in motion (e.g., video) or stationary (e.g., a still image), and whether textual or pictorial. For example, the display device 1000 may be any product or component having a display function, such as a television, a notebook computer, a tablet computer, a mobile phone, an electronic photo, an electronic billboard or sign, a personal digital assistant (PDA), a navigator, a wearable device, an augmented reality (AR) device, a virtual reality (VR) device, or the like. For example, as shown in FIG. 1, the display device 1000 may be a mobile phone.

The above display device 1000 may be a liquid crystal display device. Referring to FIG. 2, the display device 1000 may include a display panel 100 (liquid crystal display panel), a backlight assembly 200 and a glass cover plate 300. The glass cover plate 300 is provided on a light exit side of the display panel 100, for protecting the display panel 100.

As shown in FIG. 2, the display panel 100 may include at least an array substrate 110, a color filter (CF) substrate 120, and a liquid crystal layer 130 provided between the array substrate 110 and the color filter substrate 120. The color filter substrate 120 may also be called an opposite substrate, since the array substrate 110 and the color filter substrate 120 are provided oppositely. The display panel 100 may further include a frame sealant (not shown in the figure). The frame sealant is provided along peripheral edges of the array substrate 110 and the color filter substrate 120, and seals the array substrate 110 and the color filter substrate 120 to form a liquid crystal cell; and the liquid crystal layer 130 is provided in the liquid crystal cell.

The backlight assembly 200 is used to provide alight source for the display panel 100. The backlight assembly 200 may be an edge-lit backlight assembly or a direct-lit backlight assembly. In the embodiments of the present disclosure, as shown in FIG. 2, the backlight assembly 200 is described as an example of an edge-lit backlight assembly. The backlight assembly 200 may include a backlight source 210, a light guide plate 220 and a reflective sheet 230. The backlight source 210 is provided on a side of the light guide plate 220; and the reflective sheet 230 is provided on a side of the light guide plate 220 away from the display panel 100, for reflecting light emitted from the light guide plate 220 toward the reflective sheet 230 to improve the light extraction efficiency of the display panel 100.

It can be understood that the backlight assembly 200 may also include other structures, which are not specifically limited in the embodiments of the present disclosure. For example, the backlight assembly 200 may also include a diffusion sheet and/or a light-enhancing film located on the side of the light guide plate 220 away from the reflective sheet 230, which will not be described herein in detail one by one.

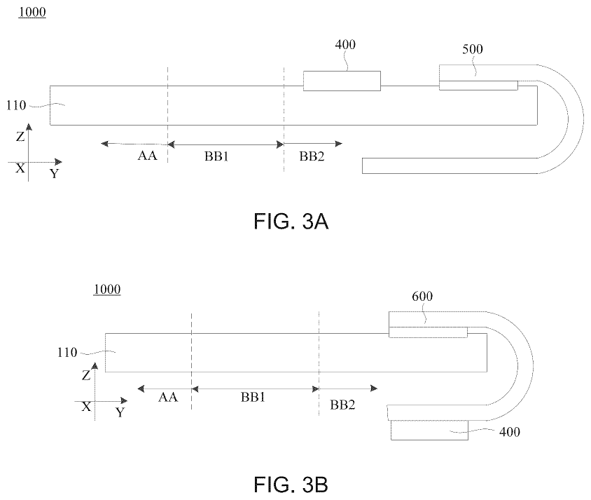

In some embodiments, as shown in FIG. 3A, the display device 1000 may further include a driver chip 400. The driver chip 400 can be directly bonded to the array substrate 110 (on a bonding region BB2). That is, the driver chip 400 adopts a chip-on-glass (COG) bonding method, which is beneficial to enhancing the adaptability of the display device 1000 to the display panel 100 and reducing the cost of the display device 1000. For example, the display device 1000 may further include a flexible circuit board (flexible printed circuit, FPC for short) 500. The flexible circuit board 500 may be used, for example, to connect the bonding region BB2 and a control component, such as a printed circuit board (PCB) or a motherboard.

In some other embodiments, as shown in FIG. 3B, the display device 1000 may further include a chip-on-film (COF) 600. The driver chip 400 may also be encapsulated within the chip-on-film 600, and is bent to a back side of the array substrate 110 with the chip-on-film 600. That is, the driver chip 400 adopts a COF bonding method. In this way, it is beneficial to reduce the width of a frame of the array substrate 110, thereby enabling the display device 1000 to achieve a narrow frame.

In the following embodiments of the present disclosure, the driver chip 400 as shown in FIG. 3A being directly bonded to the array substrate 110 is described as an example. It can be understood that the following embodiments can also be applied to the display device 1000 in which the driver chip 400 is encapsulated in the chip-on-film 600.

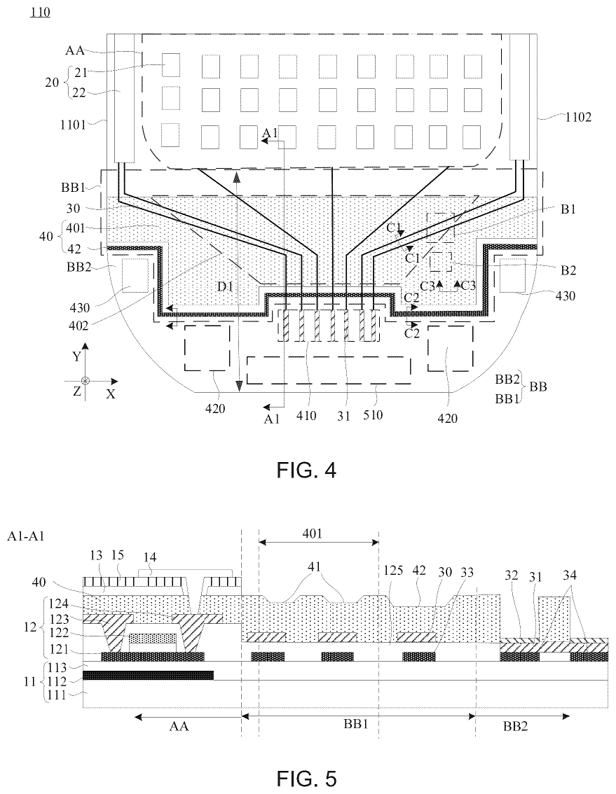

Referring to FIG. 4, where FIG. 4 is a partially enlarged view of a fan-out region and a bonding region of the array substrate, the array substrate 110 may include a display region AA and a peripheral region BB surrounding the display region AA, where only a portion of the peripheral region BB is shown in FIG. 4. The peripheral region BB includes a fan-out region BB1 and a bonding region BB2 that are located at a side of the display region AA. In the embodiments of the present disclosure, an extension direction (the horizontal direction in FIG. 4) of a boundary between the display region AA and the fan-out region BB1 is a first direction X, and an arrangement direction (the vertical direction in FIG. 4) of the display region AA, the fan-out region BB1 and the bonding region BB2 is a second direction Y, where the first direction X and the second direction cross each other. For example, the first direction X and the second direction Y are perpendicular to each other. That is to say, the display region AA, the fan-out region BB1 and the bonding region BB2 are arranged in sequence along the second direction Y; and along the second direction Y, the bonding region BB2 is further away from the display region AA than the fan-out region BB1.

The bonding region BB2 is provided therein with a first pin region 410 for bonding the driver chip 400, and a second pin region 510 for bonding the flexible circuit board 500. In some embodiments, the bonding region BB2 may further be provided therein with test pin regions 420 and ground contacts 430. The test pin region 420 may, for example, be connected to a test circuit (being a circuit structure independent of the array substrate 110) after the array substrate 110 is prepared to test whether the array substrate 110 can operate normally. That is to say, the test pin region 420 is used to detect whether the array substrate 110 is qualified. Moreover, after the subsequent module process of the array substrate (after assembly to form a display panel and a display device), the test pin region 420 may not be bonded and connected to any device. The material of the ground contact 430 may be a conductive material (such as silver), and the ground contacts 430 are used for grounding, thereby reducing the risk of the array substrate 110 being damaged by static electricity.

The first pin region 410, the second pin region 510 and the test pin regions 420 are each provided therein with multiple bonding pins 31. The bonding pin 31, which may also be referred to as a pin, or a gold finger, is a conductive structure provided within the bonding region BB1 for an electrical connection to an external device. For example, the bonding pins 31 located in the first pin region 410 can be used to be bonded to the driver chip 400, and the bonding pins 31 located in the second pin region 510 can be used to be bonded to the flexible circuit board 500. The bonding pins 31 located in the test pin region 420 can also be referred to as test pins, which are used to connect to the test circuit during the detection process of the array substrate, and after the array substrate is assembled to form a display panel and a display device, the bonding pins 31 located in the test pin region 420 may not be connected to any device and circuit. That is to say, the bonding pins 31 refer to all the pins arranged in the bonding region BB1, rather than the pins in one or more specific region. Of course, the bonding region BB1 may also include a region for connecting to other devices and provided with bonding pins, which is not specifically limited in the embodiments of the present disclosure.

It can be understood that in the embodiments of the present disclosure, the fan-out region BB1 refers to a region between the display region AA and the bonding region BB2. A demarcation line between the fan-out region BB1 and the bonding region BB2 may be a line connecting ends of multiple bonding pins 31 proximate to the display region AA and extending to two opposite sides of the array substrate 110. Moreover, the fan-out region BB1 can be understood as a region, where the connecting leads 30 are provided, which is not connected or in contact with external devices (such as the driver chip 400). The bonding region BB2 refers to a region used for bonding or providing external devices (such as the driver chip 400 and the flexible circuit board 500).

Referring to FIGS. 4 and 5, where FIG. 5 is a sectional structural diagram of a thin film transistor, some of first recessed portions, a trench, and the bonding region. The array substrate 110 may include a base 11 and a circuit structure 20 provided on the base 11. The base 11 may include a substrate 111, a light-shielding pattern 112 provided on the substrate, and a buffer layer 113 provided on the light-shielding pattern 112. The substrate 111 may, for example, be a glass substrate. The light-shielding pattern 112 is used to block a portion of the circuit structure 20 (such as blocking a semiconductor layer of the thin film transistor). The buffer layer 113 can enable the base 11 to have a flat upper surface and provide a buffer to film layers formed on the base 11. The circuit structure 20 may, for example, include pixel circuits 21 located in the display region AA and a gate driving circuit 22 located in the peripheral region.

Referring to FIG. 5, the array substrate 110 includes thin film transistors (TFTs) 12 provided on the base 11, a planarization layer 40, a common electrode 13, pixel electrodes 14 and an insulating layer 15 located between the common electrode 13 and the pixel electrode 14. The thin film transistor 12 includes a semiconductor layer 121, a gate 122, a source 123 and a drain 124. The array substrate 110 may further include a gate insulating layer located between the semiconductor layer 121 and the gate 122, an interlayer insulating layer located between the gate 122 and the source 123 (drain 124), etc., which will not be described herein in detail one by one. The planarization layer 40 is provided above a film layer where the source 123 and the drain 124 are located, and provided therein with via holes (through holes). The pixel electrode 14 can be electrically connected to the drain 124 of the thin film transistor through a via hole. Both the pixel circuit 21 and the gate driving circuit 22 may include multiple thin film transistors 12, and the embodiments of the present disclosure do not specifically limit the pixel circuit 21 and the gate driving circuit 22.

As shown in FIG. 4, the array substrate 110 further includes a plurality of connecting leads 30. Only a few connecting leads 30 are illustrated in FIG. 4, which should not be construed as limiting the positions, quantity, and wiring arrangement of the connecting leads 30. The plurality of connecting leads 30 are provided on the base 11 and located in the fan-out region BB1. The plurality of connecting leads 30 may be provided in the same layer as the source 123 and the drain 124. That is, the connecting leads 30, the source 123 and the drain 124 may be in a film layer with specific patterns formed using the same film formation process.

In the embodiments of the present disclosure, the plurality of connecting leads 30 being located in the fan-out region BB1 can be understood to mean that at least a portion of the plurality of connecting leads 30 is located in the fan-out region BB1. For example, the connecting leads 30 may extend from the gate driving circuit 22 in the peripheral region BB, through the fan-out region BB1 and to the bonding region BB2, or may extend from the display region AA through the fan-out region BB1 and to the bonding region BB2. The plurality of connecting leads 30 can be used to connect the gate driving circuit 22 and the bonding pins 31 (also called gold fingers, pads, etc.) in the bonding region BB2. The plurality of connecting leads 30 may, for example, be used for transmitting start signals, clock signals, data signals, etc., which are not specifically limited in the embodiments of the present disclosure.

As shown in FIG. 5, the array substrate 110 may further include first conductive blocks 33 located in the fan-out region BB1 and second conductive blocks 34 located in the bonding region BB2. The first conductive blocks 33 and the second conductive blocks 34 may be made of the same material as the gate 122 of the thin film transistor 12 and are provided in the same layer as the gate 122 of the thin film transistor 12.

A first conductive block 33 may extend along an arrangement direction (such as the first direction) of the plurality of connecting leads 30, and the first conductive block 33 is used to connect at least two connecting leads for transmitting the same signal. The fan-out region BB1 is provided therein with the plurality of connecting leads 30, so the connecting leads 30 are arranged in a relatively high density, and non-adjacent connecting leads 30 can be connected through the first conductive block 33. For example, an interlayer insulating layer 125 is provided between the first conductive block 33 and the connecting leads 30. A connecting lead 30, which needs to be electrically connected to the first conductive block 33, may be electrically connected to the first conductive block 33 through a via hole (not shown in the figure) through the interlayer insulating layer 125. In this way, the first conductive block 33 can be effectively prevented from contacting other connecting leads (the connecting leads that do not need to be electrically connected), and the risk of signal crosstalk between different connecting leads 30 may be reduced.

The second conductive block 34 is used to electrically connect to the bonding pins 31 in the first pin region and/or the second pin region to reduce the contact resistance between the bonding pins 31 and both the driver chip and the flexible circuit board 500. For example, a second conductive block 34 is provided on a side of the bonding pin 31 proximate to the base, and the second conductive block 34 is in direct contact with the bonding pin 31. That is to say, there is no interlayer insulating layer 125 between the second conductive block 34 and the bonding pin 31. In this way, it is beneficial to increase the contact area between the second conductive block 34 and the bonding pin 31, reduce the contact resistance between the second conductive block 34 and the bonding pin 31, and facilitate a signal transmission between the bonding pin 31, the driver chip, and the flexible circuit board, reducing energy consumption.

It can be understood that the bonding region BB2 has a large space, and there is sufficient space to design the bonding pins 31, and a distance between the bonding pins 31 is large, so there will be no risk of signal crosstalk and short circuit. Therefore, the interlayer insulating layer 125 on a side of the bonding pin 31 proximate to the base 11 can be completely removed, so that the second conductive block 34 can be directly provided on the bonding pin 31. Moreover, a patterning process of the interlayer insulating layer 125 in the bonding region BB2 is relatively simple, which is beneficial to reducing the difficulty of manufacturing the display panel.

In some embodiments, as shown in FIG. 5, a surface of the bonding pins 31 away from the base 11 may further be provided with one or more layers of third conductive blocks 32. Similar to the second conductive blocks 34, the third conductive blocks 32 can reduce the contact resistance between the bonding pins 31 and both the driver chip and the flexible circuit board 500, which is beneficial to reducing the power consumption of the display panel, and will not be described again here.

For example, the array substrate 110 may further include a layer of third conductive blocks 32 provided on the bonding pins 31. The third conductive block 32 may be made of the same material as the common electrode 13 and arranged in the same layer as the common electrode 13, or the third conductive block 32 may be made of the same material as the pixel electrode 14 and arranged in the same layer as the pixel electrode 14.

In some embodiments, as shown in FIG. 2, the array substrate 110 further includes an alignment film 140. The alignment film 140 can be provided on a side of the planarization layer 40 in the array substrate away from the base 11, that is, located on a side of the array substrate 110 relatively proximate to the liquid crystal layer 130. The color filter substrate 120 also includes an alignment film 140. The alignment film 140 of the color filter substrate 120 is provided in the color filter substrate 120 and is located on a side proximate to the liquid crystal layer 130. The above alignment film 140 is used to control an alignment direction of liquid crystal molecules in the liquid crystal layer 130. Specifically, the alignment film 140 can be used to control the arrangement direction of the liquid crystal molecules without the action of an electric field. It can also be understood that the alignment film 140 is used to define a pretilt angle of liquid crystal molecules.

Here, during a process of applying an alignment liquid (which is a solution used to form the alignment film) on structures formed in the array substrate 110 to form the alignment film, the alignment liquid will flow along a surface of these structures formed in the array substrate. As a result, it is necessary to prevent the alignment liquid from flowing into the bonding region (on the bonding pins) and affecting the electrical connection between the bonding region and other components (such as the driver chip and FPC) to ensure the reliability of the array substrate.

However, in the related art, with the development of narrow frames in display panels, a distance (a width of a fan-out region) between a display region and a bonding region is getting smaller and smaller, and a density of connecting leads in the fan-out region is getting larger and larger. As a result, the width of connecting leads (a dimension of the connecting leads perpendicular to an extension direction thereof) is getting smaller and smaller, and a distance between the connecting leads is getting smaller and smaller. For example, the width of the connecting leads is less than 2 μm or less than 2.5 μm, and the distance between adjacent connecting leads is less than 2 μm or less than 2.5 μm. In light of this, the space for arranging a groove on a planarization layer is getting smaller and smaller, especially in the related art, the groove is only arranged in a gap between the connecting leads. In this case, there is insufficient space for the groove on the planarization layer, resulting in an increasing risk of the alignment liquid flowing into the bonding region.

In order to solve the above technical problems, reduce the risk of the alignment liquid flowing to the bonding region BB2 of the array substrate 110, and improve the reliability of the array substrate 110 in the display panel 100 (with narrow frame), in the display panel 100 provided by the embodiments of the present disclosure, as shown in FIG. 4, the planarization layer 40 includes a first pattern region 401 located in the fan-out region BB1.

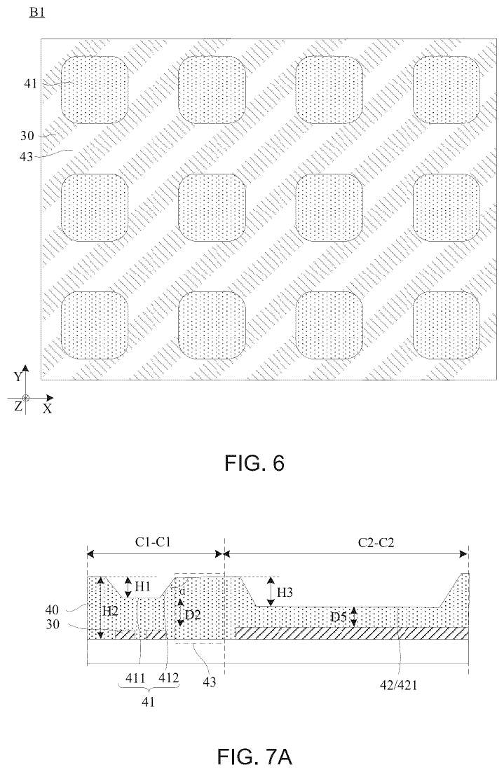

Referring to FIG. 5, the first pattern region 401 is provided with a plurality of first recessed portions 41; and along a direction perpendicular to the base 11, a first recessed portion 41 and a connecting lead 30 have a distance therebetween. Referring to FIG. 6, an orthographic projection of at least one first recessed portion 41 on the base 11 overlaps with an orthographic projection of at least one connecting lead 30 on the base 11. That is to say, the first recessed portions 41 are provided on a side of the connecting leads 30 away from the base 11, so the first recessed portions 41 do not need to avoid the connecting leads 30, which is beneficial to increasing a region where the first recessed portions 41 is arranged in the fan-out region BB1, increasing the quantity of the first recessed portions 41, and increasing opening areas of the first recessed portions 41, thereby increasing the area ratio of the first recessed portions 41, improving the capacity of the fan-out region BB1 to absorb and accommodate the alignment liquid, and reducing the risk of the alignment liquid flowing to the bonding region. Moreover, it is also beneficial to reduce the width of the fan-out region BB1, thereby reducing the frame width of the display panel 100.

As shown in FIG. 5, along the direction perpendicular to the base 11, a first recessed portion 41 and a connecting lead 30 have a distance therebetween, which can prevent the first recessed portion 41 from exposing the connecting lead 30, protect the connecting lead 30, and reduce the risk of exposing and damaging the connecting lead 30 during the subsequent manufacturing of the display panel 100.

It can be understood that the projection relationship, shown in FIG. 6, between the first recessed portion 41 and the connecting lead 30 is only an example, and is not a limitation of the present disclosure. An orthographic projection of at least one first recessed portion 41 on the base 11 overlapping with an orthographic projection of at least one connecting lead 30 on the base 11, may be an orthographic projection of each first recessed portion 41 partially overlapping with an orthographic projection of at least one connecting lead 30. For example, an orthographic projection of each first recessed portion 41 partially overlaps with an orthographic projection of each of one or two or more connecting leads 30, and the quantity of connecting leads 30 whose orthographic projections partially overlap with orthographic projections of different first recessed portions 41 may be the same or different. For example, in a region where connecting leads 30 are densely arranged, an orthographic projection of each first recessed portion 41 partially overlaps with orthographic projections of two connecting leads 30; and in a region where connecting leads 30 are sparsely arranged, the orthographic projection of the first recessed portion 41 partially overlaps with an orthographic projection of one connecting lead 30.

An orthographic projection of at least one first recessed portion 41 on the base 11 overlapping with an orthographic projection of at least one connecting lead 30 on the base 11, may also be that orthographic projections of some of the first recessed portions 41 partially overlap with an orthographic projection of at least one connecting lead 30, and orthographic projections of some of the first recessed portions 41 are non-overlapping with (separated from) an orthographic projection of any connecting lead 30. An orthographic projection of the first recessed portion 41 partially overlaps with an orthographic projection of at least one connecting lead 30, as described above, which will not be described again here. For example, orthographic projections of some of the first recessed portions 41 non-overlapping with an orthographic projection of the connecting lead 30 may be that, in a region where connecting leads 30 are sparsely arranged, some of the first recessed portions 41 are located between two adjacent connecting leads 30; alternatively, some of the first recessed portions 41 are arranged in a region in the fan-out region where no connecting lead 30 is provided.

Based on the above, in the embodiments of the present disclosure, the first recessed portions 41 can be understood as grooves each with approximately the same opening size and depth along the direction perpendicular to the base 11 (a third direction Z). That is to say, except for the different positions, the structures, and sizes of the plurality of first recessed portions 41 are the same or substantially the same. Here, due to the uniformity and precision error of the manufacturing process, there may be certain deviations in the structure and size of the plurality of first recessed portions 41. For example, the deviation range of the plurality of first recessed portions 41 is less than or equal to 5%, or the deviation range is less than or equal to 10%, and the embodiments of the present disclosure do not specifically limit this.

In some embodiments, as shown in FIG. 4, the fan-out region BB1 includes a first wiring region 402 and a second wiring region (not shown in the figure), with an arrangement density of connecting leads 30 in the first wiring region 402 greater than an arrangement density of connecting leads in the second wiring region. For example, the first wiring region 402 may be a region in the fan-out region that is proximate to the first pin region 410, the test pin region 420, and the second pin region 510; and the second wiring region may be a region at both sides of the fan-out region along the first direction X or another region. The embodiments of the present disclosure do not specifically limit the specific arrangement and arrangement region of the connecting leads 30 in the fan-out region.

Referring to FIG. 6, in the first wiring region 402, a width of the connecting lead 30 is in a range of 1.5 μm to 1.9 μm, inclusive. For example, the width of the connecting lead is 1.5 μm, 1.7 μm, or 1.9 μm, which will not be described in the embodiments of the present disclosure. Here, the width of the connecting lead 30 refers to a dimension at any position of the connecting lead 30 along a direction perpendicular to an extension direction of the connecting lead 30, which may also be understood as a minimum distance between two opposite side edges of the connecting lead 30. A distance between two adjacent connecting leads 30 is in a range of 1.6 μm to 2.0 μm, inclusive. For example, the distance between the two adjacent connecting leads 30 may be 1.6 μm, 1.8 μm, or 2.0 μm. In this way, it is beneficial to further reduce a width of the fan-out region BB1 along the second direction X, thereby achieving a narrow frame of the display panel 100. In the first wiring region, the orthographic projection of the first recessed portion 41 on the base 11 overlaps with orthographic projections of at least two connecting leads 30 on the base 11, which is beneficial to increasing the size of the first recessed portion 41, increasing the area ratio of the first recessed portion 41 in the first pattern region 401, and increasing the capacity of the first recessed portion 41 to absorb and accommodate the alignment liquid.

In some embodiments, as shown in FIG. 4, a boundary of the display region AA proximate to the bonding region BB2 and a boundary of the bonding region BB2 away from the display region AA have a distance D1 therebetween, where the distance D1 is less than or equal to 2.4 mm. In this way, the array substrate 110 can be used to prepare a display panel 100 with an extremely narrow frame, which is beneficial to narrowing the frame of the display device 1000.

For example, the distance D1 between the boundary of the display region AA proximate to the bonding region BB2 and the boundary of the bonding region BB2 away from the display region AA is 2.37 mm. Along the second direction Y, a distance between the second pin region 510 and the boundary of the bonding region BB2 away from the display region AA may be 0.07 mm; a width of the second pin region 510 is 0.3 mm; a distance between the second pin region 510 and the first pin region 410 may be 0.2 mm; a width of the first pin region 410 may be 0.95 mm; and a distance between the display region AA and the first pin region 410 may be 0.85 mm.

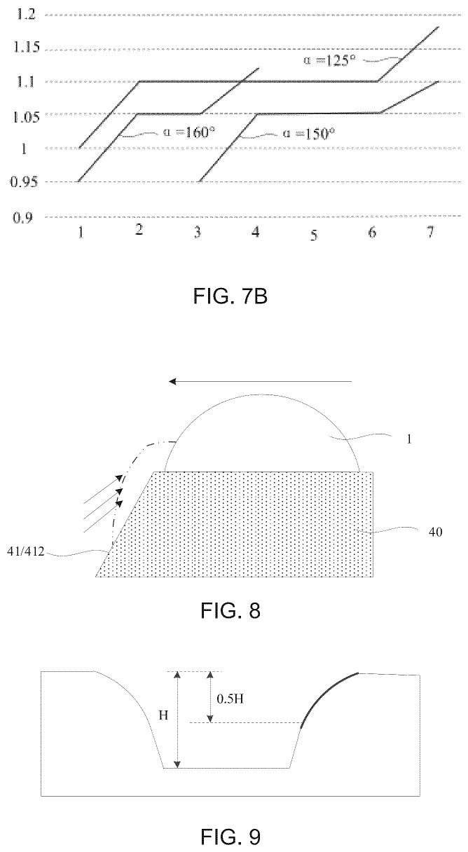

In some embodiments, referring to FIGS. 5 and 7A, along the direction perpendicular to the base (the third direction Z), a ratio of a depth H1 of the first recessed portion 41 to a thickness H2 of the planarization layer 40 is in a range of 0.25 to 0.65, inclusive. That is, the range of H1/H2 is 0.25 to 0.65, inclusive. In this way, the first recessed portion 41 can absorb and accommodate the alignment liquid, while protecting the connecting lead 30 at the side of the first recessed portion 41 proximate to the base 11. For example, the ratio of the depth H1 of the first recessed portion 41 to the thickness H2 of the planarization layer 40 may be 0.25, 0.4, 0.55, or 0.65, which will not be listed one by one in the embodiments of the present disclosure.

It can be understood that thicknesses H2 of portions of the planarization layer 40 located in different regions may have certain differences. For example, a thickness of a portion of the planarization layer 40 that is located in the display region AA is different from a thickness of a portion of the planarization layer 40 that is located in the fan-out region BB1; and a thickness of a portion of the planarization layer 40 that is in contact with the connecting leads 30 may also be different from a thickness of a portion of the planarization layer 40 that is in contact with the interlayer insulating layer 125. In light of this, in the embodiments of the present disclosure, the ratio of the depth H1 of the first recessed portion 41 to the thickness H2 of the planarization layer 40 can be understood as a ratio of the depth H1 of the first recessed portion 41 to a thickness of a portion of the planarization layer 40 in a region where the first recessed portion 41 is located.

For example, the thickness of the portion of the planarization layer 40 that is located in the fan-out region BB1 may be in a range of 2.3 μm to 2.5 μm, inclusive; and the depth H1 of the first recessed portion 41 may be in a range of 1.0 μm to 1.5 μm, inclusive. For example, the thickness of the portion of the planarization layer 40 that is located in the fan-out region BB1 is 2.3 μm, 2.4 μm, or 2.5 μm; and the depth H1 of the first recessed portion 41 is 1.0 μm, 1.3 μm, or 1.5 μm, which will not be listed one by one in the embodiments of the present disclosure.

In some embodiments, referring to FIGS. 5 and 7A, FIG. 7A is a sectional structural diagram of a first recessed portion 41 and a portion of the trench. The first recessed portion 41 includes a first bottom wall 411. A distance between the first bottom wall 411 and the connecting lead 30 along the direction (the third direction Z) perpendicular to the base 11 is D2, where D2 is greater than or equal to 1 μm. That is, the thickness of a portion of the planarization layer 40 that is on the upper side of the connecting lead 30 is greater than or equal to 1 μm. In this way, it is beneficial to improve the flatness of the first bottom wall 411 of the first recessed portion 41, and ensure that the planarization layer 40 can protect the connecting leads 30 below, thereby reducing the risk of the connecting leads 30 being exposed during the subsequent manufacturing process of the display panel 100.

In some embodiments, continuing to refer to FIG. 7A, the first recessed portion 41 further includes a first side wall 412, and a variation of a slope of a tangent line of the first side wall 412 is less than or equal to 0.1. That is to say, the first side wall 412 of the first recessed portion 41 is substantially a straight slope surface. In this way, a sharp (compared to a circular arc angle) obtuse angle α can be formed at the top end of the first side wall 412 (one end away from the base 11) and the upper surface of the planarization layer 40 (the surface away from the base 11 in a region that has not been patterned).

Here, the slope of the tangent line of the first side wall 412 refers to, in a section perpendicular to the base 11 and passing through the first recessed portion 41, a slope of a tangent line of the first side wall 412 at various positions from a position in contact with the first bottom wall 411 to the upper surface of the planarization layer 40 relative to a plane where the base is located. In addition, in order to clearly identify starting and ending positions of the first side wall 412, that is to say, in order to clarify a range of the first side wall, a side wall within a certain depth range of the first recessed portion 41 can be defined as the first side wall. For example, a side wall, which corresponds to a portion of the depth H1 of the first recessed portion 41 from 10% to 90%, is the first side wall 412. The embodiments of the present disclosure do not specify the range of the depth H1 of the first recessed portion 41 corresponding to the first side wall 412. As another example, the first side wall 412 may correspond to a portion of the depth H1 of the first recessed portion 41 from 5% to 95% or from 20% to 80%. Based on this, the variation of the slope of the tangent line of the first side wall 412 is less than or equal to 0.1, which may mean that the variation of the slope of the tangent line of the first side wall 412 is less than or equal to 0.1 in 10% to 90% section of the depth H1 of the first recessed portion 41. That is to say, a difference between the maximum value and the minimum value of the slope of the tangent line of the first side wall 412 in the 10% to 90% section of the depth H1 of the first recessed portion 41 is less than or equal to 0.1.

Referring to FIGS. 8 and 9, compared with the smooth arc angle, the top end of the first side wall 412 and the upper surface of the planarization layer 40 form a sharp obtuse angle α, so that during the process of the alignment liquid 1 flows into the first recessed portion 41 (from the right flows to the left, as shown in the single arrow line), the contact area with a solid phase (the planarization layer 40) is reduced, the cohesion effect of the alignment liquid 1 is enhanced, and it is difficult for the alignment liquid 1 to flow into the first recessed portion 41. Meanwhile, the contact area between the alignment liquid 1 and a gas phase (air) becomes larger, so the air can play a role in lifting the alignment liquid 1, as shown in the three arrow lines, and the suspended alignment liquid can be lifted by the gas phase below, making it more difficult for the alignment liquid 1 to flow into the first recessed portion 41. That is to say, the blocking effect of the first recessed portion 41 on the alignment liquid 1 can be improved, which is conducive to reducing the flow speed of the alignment liquid 1, thereby further reducing a flow distance (an overflow distance) of the alignment liquid 1. Based on the increased blocking effect of the first recessed portion 41 on the alignment liquid 1, on the premise of ensuring that the alignment liquid 1 does not flow to the bonding region, the quantity of the first recessed portions 41 can be reduced and/or the size of an individual first recessed portion 41 can be reduced. That is, reducing the space occupied by the first recessed portions 41, is beneficial to achieving a narrow frame of the display panel 100.

In the related art, as shown in FIG. 9, a side wall of a formed groove forms a rounded (smooth) arc angle with the upper surface of the planarization layer. In this way, during the process of the alignment liquid flowing into the groove, the contact area between the alignment liquid and the planarization layer is larger, the cohesion effect of the alignment liquid is weakened, and the alignment liquid flows more easily into the groove. Moreover, when the flow rate of the alignment liquid is fast, the alignment liquid can relatively easily overflow from the groove along the side wall, which is not conducive to absorbing and accommodating the alignment liquid for the groove. Here, a depth of this groove is H, and a distance between the bottom and top of the arc angle is 0.5 H.

Compared with the prior art, in the embodiments of the present disclosure, the top end of the first side wall 412 and the upper surface of the planarization layer 40 form a sharp obtuse angle α, which can improve the blocking effect of the first recessed portion 41 on the alignment liquid 1, reduce the flow distance of the alignment liquid 1, and be conducive to achieving a narrow frame of the display panel 100.

In some embodiments, referring to FIGS. 5 and 7A, the first pattern region 401 further includes a connecting portion 43, and the connecting portion 43 is located in gaps between the plurality of first recessed portions 41 and connecting the plurality of first recessed portions 41. It can also be understood that the connecting portion 43 is a portion in the first pattern region BB1 that has not been patterned (a portion in which no trenches, pits, holes, etc. are formed). An included angle α between a surface of the connecting portion 43 away from the base 11 and the first side wall 412 is in a range of 125° to 160°, inclusive. That is, the inclination angle of the first side wall 412, i.e., an acute angle formed by the first side wall 412 with a plane parallel to the base 11, is in a range of 20° to 55°, inclusive. In this way, it is beneficial to increase the size of the space formed by the first recessed portion 41, thereby increasing the capacity of the first recessed portion 41 to absorb and accommodate the alignment liquid, increasing the blocking effect of the first recessed portion 41 on the alignment liquid, and reducing the distance of the alignment liquid flowing along the array substrate 110. For example, the included angle α between the surface of the connecting portion 43 away from the base 11 and the first side wall 412 may be 125°, 150°, or 160°, which will not be described in detail one by one in the embodiments of the present disclosure.

In some embodiments, the included angle α between the surface of the connecting portion 43 away from the base 11 and the first side wall 412 of the first recessed portion 41 is in a range of 150° to 155°, inclusive. That is to say, the inclination angle of the first side wall 412 is in a range of 250° to 30°, inclusive. In this way, the included angle α between the surface of the connecting portion 43 away from the base 11 and the first side wall 412 is relatively small, which is beneficial to reducing the difficulty of manufacturing the first recessed portion 41 and thereby reducing the manufacturing cost of the array substrate 110. For example, the included angle α between the surface of the connecting portion 43 away from the base 11 and the first side wall 412 may be 150°, 152°, or 155°, which will not be listed one by one in the embodiments of the present disclosure.

Referring to FIG. 7B, the inventors of the present disclosure further verified that, in a case where the included angle α between the surface of the connecting portion 43 away from the base 11 and the first side wall 412 of the first recessed portion 41 is 160° (the inclination angle of the first side wall 412 is 20°), 150° (the inclination angle of the first side wall 412 is 30°) and 125° (the inclination angle of the first side wall 412 is 55°), respectively, the magnitude of the surface tension of the alignment liquid on the planarization layer 40. FIG. 7B shows results of a plurality of testing points sequentially selected in the portion of the planarization layer 40 located in the fan-out region BB1 along the second direction Y and away from the display region AA. The testing points can be selected arbitrarily as needed. It has been verified that in the case where the included angle α between the surface of the connecting portion 43 away from the base 11 and the first side wall 412 is in the range of 125° to 160°, inclusive, each first recessed portion 41 can effectively block the alignment liquid.

As shown in FIG. 7B, in a case where the included angle α between the surface of the connecting portion 43 away from the base 11 and the first side wall 412 is 125°, the alignment liquid has a large surface tension on the planarization layer 40, and the first recessed portion 41 has the strongest blocking effect on the alignment liquid; alternatively, in a case where the included angle α is 150° or 160°, the alignment liquid has a surface tension of 1.05 N on the planarization layer 40, but in the case where the included angle α is 150°, the alignment liquid maintains stress on the planarization layer 40 for a longer time, so the planarization layer 40 has a better blocking effect. For example, in order to balance the difficulty of preparing the first recessed portion 41 and the resistance of the first recessed portion 41 to the alignment liquid, the included angle α between the surface of the connecting portion 43 away from the base 11 and the first side wall 412 can be set to 140°, 150°, 155°, or the like, which will not be listed one by one in the embodiments of the present disclosure.

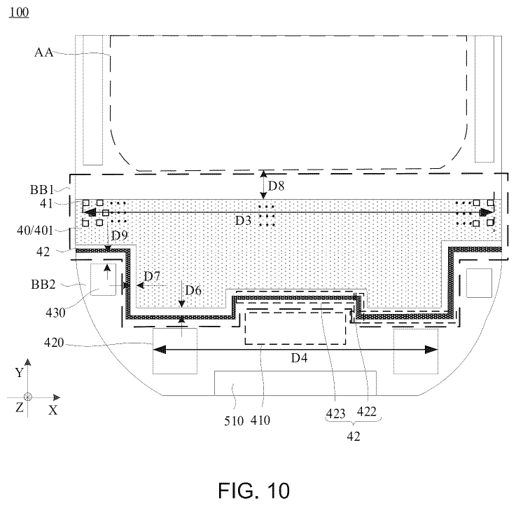

In some embodiments, referring to FIG. 10, along the first direction X, a distance D3 between outer boundaries of two first recessed portions 41 furthest away from each other is greater than a distance D4 between outer boundaries of two bonding pins 31 furthest away from each other in the bonding region BB2. Here, the distance between the outer boundaries of the two bonding pins 31 furthest away from each other in the bonding region BB2 may be a distance between outer boundaries of two bonding pins 31 located in two testing pin regions 420, away from the first pin region 410. Here, the first direction X and the second direction Y intersect with each other. For example, the first direction X and the second direction Y are perpendicular to each other. That is to say, along the second direction Y, the first recessed portions 41 are provided at various positions opposite the bonding pins 31. In this way, it is conducive to improving the absorption and accommodation capacity of the first recessed portion 41 for the alignment liquid, and to preventing the alignment liquid from passing through the fan-out region BB1 from both sides of the fan-out region BB1 without passing through the first recessed portion 41, thereby reducing the risk of the alignment liquid flowing to the bonding region BB2. For example, referring to FIG. 10, the distance between the outer boundaries of the two bonding pins 31 furthest away from each other in the bonding region BB2 may be a distance between outer boundaries of the two test pin regions 420.

In some embodiments, as shown in FIG. 10, the plurality of first recessed portions 41 are arranged in multiple rows, and the multiple rows of first recessed portions 41 are spaced apart along the second direction Y. Any two adjacent rows of first recessed portions 41 are staggered along the first direction X. In this way, the multiple rows of first recessed portions 41 can absorb the alignment liquid in multiple ways and reduce the flow distance of the alignment liquid. Moreover, the first recessed portions 41 can be provided at various positions of the fan-out region BB1 along the first direction X, preventing the alignment liquid from directly passing through the fan-out region BB1 from the gaps between the first recessed portions 41, and improving the absorption effect of the plurality of the first recessed portions 41 on the alignment liquid. Here, FIG. 10 only exemplarily illustrates a portion of three rows of first recessed portions 41, and the plurality of first recessed portions 41 can be evenly arranged in the first pattern region 401.

In some embodiments, referring to FIG. 4, the planarization layer 40 further includes a trench 42. The trench 42 is located in the fan-out region BB1 and is further away from the display region AA than the first pattern region 401. The array substrate 110 includes a first side edge 1101 and a second side edge 1102 that are opposite to each other in the first direction X, and the trench 42 extends from the first side edge 1101 to the second side edge 1102. That is to say, along the first direction X, both ends of the trench 42 are flush with boundaries of the array substrate 110, respectively. The trench 42 is continuously provided and extends through the fan-out region along the length of the first direction X. In this way, no matter whether the alignment liquid flows out of the first pattern region 401 from any position of the first pattern region 401, it can flow into the trench 42, so that the trench 42 plays a role in intercepting the alignment liquid and improves the capacity of the trench 42 to accommodate the alignment liquid.

In some embodiments, an orthographic projection of the trench 42 on the base 11 partially overlaps with an orthographic projection of at least one connecting lead 30 on the base 11. That is to say, the trench 42 is provided on a side of the connecting lead 30 away from the base 11. The trench 42 does not need to avoid the connecting lead 30, which is beneficial to improving an arrangement region of the trench 42 in the fan-out region BB1, so that the trench 42 can extend through the fan-out region BB1 along the first direction and improve the capacity of the trench 42 to absorb and accommodate the alignment liquid.

Along the direction perpendicular to the base (the third direction Z), a ratio of a depth H3 of the trench 42 to the thickness H2 of the planarization layer 40 is in a range of 0.25 to 0.65, inclusive. That is, the range of H3/H2 is 0.25 to 0.65, inclusive. In this way, the trench 42 can absorb and accommodate the alignment liquid, while protecting the connecting leads 30 on the side of the trench 42 proximate to the base 11. For example, the ratio of the depth H3 of the trench 42 to the thickness H2 of the planarization layer 40 may be 0.25, 0.35, 0.5, or 0.65, which will not be listed one by one in the embodiments of the present disclosure.

For example, the thickness H2 of the portion of the planarization layer 40 located in the fan-out region BB1 may be in a range of 2.3 μm to 2.5 μm, inclusive; and the depth H3 of the trench 42 may be in a range of 1.0 μm to 1.5 μm, inclusive. For example, the thickness of the portion of the planarization layer 40 located in the fan-out region BB1 is 2.3 μm, 2.4 μm, or 2.5 μm. The depth H1 of the first recessed portion 41 is 1.0 μm, 1.3 μm, or 1.5 μm, which will not be listed one by one in the embodiments of the present disclosure.

Referring to FIG. 7A, the trench 42 includes a second bottom wall 421, and a distance between the second bottom wall 421 and the connecting lead 30 is greater than or equal to 1 μm along the direction perpendicular to the base 11. The distance between the second bottom wall 421 and the connecting lead 30 is D5, and D5 is greater than or equal to 1 μm. In this way, it is beneficial to improve the flatness of the second bottom wall 421 of the trench 42, and ensure that the planarization layer 40 can protect the connecting leads 30 below, thereby reducing the risk of the connecting leads 30 being exposed during the subsequent manufacturing process of the display panel 100.

In some embodiments, continuing to refer to FIG. 7A, the depth H3 of the trench 42 is greater than the depth H1 of the first recessed portion 41. That is to say, the distance D5 between the second bottom wall 421 of the trench 42 and the connecting lead 30 is less than the distance D2 between the first bottom wall 411 of the first recessed portion 41 and the connecting lead 30. In the embodiments of the present disclosure, the first recessed portion 41 and the trench 42 with different depths are formed in the planarization layer 40, which is beneficial to further increase the volume of the trench 42 and thereby improve the capacity of the trench 42 to absorb and accommodate the alignment liquid. Serving as the last barrier to intercept the alignment liquid, the deeper trench is conducive to improving the capacity of the trench 42 to absorb and accommodate the alignment liquid, further improving the capacity of the fan-out region BB1 to absorb and accommodate the alignment liquid, and reducing the risk of the alignment liquid flowing to the bonding region.

For example, the distance D2 between the first bottom wall 411 of the first recessed portion 41 and the connecting lead 30 is 1.5 μm, 1.6 μm, or 1.7 μm, and the distance D5 between the second bottom wall 421 of the trench 42 and the connecting lead 30 is 1.0 μm, 1.1 μm or 1.2 μm.

In some embodiments, continuing to refer to FIG. 10, a demarcation line between the fan-out region BB1 and the bonding region BB2 is a polyline. A boundary of the first pattern region 401 may have a similar shape to the demarcation line of the fan-out region BB1 and the bonding region BB2. In this way, it is beneficial to maximize the area of the first pattern region 401 to be able to provide a greater quantity of first recessed portions 41, and to improve the capacity of the first recessed portions 41 to absorb and accommodate the alignment liquid.

In a case where the demarcation line between the fan-out region BB1 and the bonding region BB2 is a polyline, the boundary of the first pattern region 401 proximate to the bonding region BB2 is also a polyline. The trench 42 extends along the boundary of the first pattern region 401 proximate to the bonding region BB2. That is to say, an extension direction of the trench 42 is also in a polyline.

For example, as shown in FIG. 10, the trench 42 includes multiple first sub-sections 422 and multiple second sub-sections 423 that are alternately connected in sequence. The first sub-sections 422 extend along the second direction Y, and the second sub-sections 423 extend along the first direction X. Both ends of the trench 42 are two second sub-sections 423. A distance D6 between the first sub-section 422 and the first pattern region 401 is substantially equal to a distance D7 between the second sub-section 423 and the first pattern region 401.

In some embodiments, referring to FIG. 10, along the second direction Y, a distance between the first pattern region 401 and the display region AA is D8, and D8 is in a range of 100 μm to 200 μm, inclusive. This facilitates recognizing by vision (e.g., a camera) whether or not a formed alignment film is beyond the boundary of the display region AA, and facilitates determining whether or not the alignment film complies with the manufacturing requirements. For example, the distance D8 between the first pattern region 401 and the display region AA may be 100 μm, 130 μm, 185 μm, or 200 μm, which will not be listed one by one in the embodiments of the present disclosure.

The distance D6 between the first pattern region 401 and the trench 42 is in a range of 5 μm to 50 μm, inclusive. This is beneficial to separate the trench 42 from the first recessed portion 41, prevent the first recessed portion 41 from being communicating with the trench 42, and improve the capacity of the first recessed portion 41 and the trench 42 to store the alignment liquid, and enable the first recessed portion 41 and the trench 42 to independently absorb and accommodate the alignment liquid. For example, the distance D6 between the first pattern region 401 and the trench 42 may be 5 μm, 20 μm, 45 μm, or 50 μm, which will not be listed one by one in the embodiments of the present disclosure.

As shown in FIG. 10, a distance between the trench 42 and the bonding region BB2 is D9, and D9 is in a range of 5 μm to 50 μm, inclusive. In this way, the trench 42 can be prevented from communicating with other openings in the bonding region BB2 (such as openings used for bonding the driver chip, FPC, etc.), and the safety buffer interval of the bonding region BB2 can be improved, even if there is a trace amount of alignment liquid rushes out of the trench 42 due to an excessive flow rate, it will not further flow into the bonding region BB2.

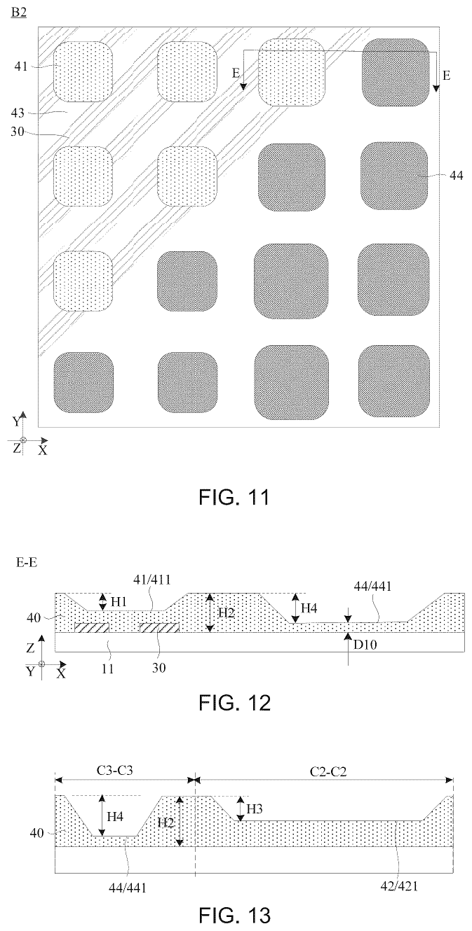

In some embodiments, referring to FIGS. 11 and 12, the first pattern region 401 further includes a plurality of second recessed portions 44, and orthographic projections of the second recessed portions 44 on the base 11 are non-overlapping with orthographic projections of the connecting leads 30 on the base 11. That is to say, the second recessed portions 44 may be provided in a region in the first pattern region 401 where the connecting leads 30 are not provided. There is no connecting lead 30 on a side of the second recessed portions 44 proximate to the base 11. Therefore, there is no need to worry about the second recessed portions 44 exposing the lower connecting leads 30. Based on this, a depth H4 of the second recessed portion 44 is greater than the depth H1 of the first recessed portion 41. It is beneficial to increase the volume of the second recessed portion 44 (compared to the first recessed portion 41) and improve the capacity of the second recessed portion 44 to absorb and accommodate the alignment liquid.

For example, as shown in FIG. 12, the second recessed portion 44 includes a third bottom wall 441, and a distance D10 between the third bottom wall 441 of the second recessed portion 44 and the surface of the planarization layer 40 proximate to the base 11 may be less than or equal to 1 μm, that is to say, the thickness of a portion of the planarization layer 40 at the bottom of the second recessed portion 44 is less than 1 μm. For example, the distance D10 between the third bottom wall 441 of the second recessed portion 44 and the surface of the planarization layer 40 proximate to the base 11 may be 0.2 μm, 0.5 μm, 0.8 μm, or 1 μm.

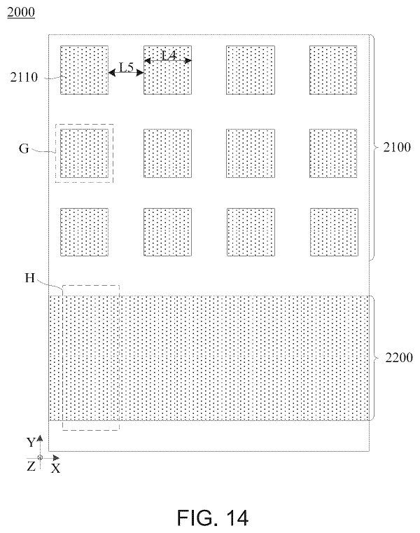

It can be understood that in a case where the depth H3 of the trench 42 is also greater than the depth H1 of the first recessed portion 41, the depth H4 of the second recessed portion 44 and the depth H3 of the trench 42 may or may not be equal. For example, as shown in FIG. 13, the depth H4 of the second recessed portion 44 is greater than the depth H3 of the trench 42.

As can be seen from the above embodiments, the planarization layer 40 includes the through holes, the trench 42, the first recessed portions 41 and the second recessed portions 44 with different depths. When using a conventional half-tone mask to prepare the above planarization layer 40, it is necessary to set up multiple regions with different transmittances. The manufacturing cost of the half-tone mask is high and implementation is difficult.

In order to solve the above technical problems, referring to FIG. 14, some other embodiments of the present disclosure provide a mask 2000 for manufacturing the array substrate 110 described in any of the above embodiments, and specifically may be for manufacturing the planarization layer 40 described in any of the above embodiments.

It can be understood that the manufacturing process of the planarization layer 40 includes coating, exposure, and development. The coating refers to forming a continuous entire layer of an initial planarization layer, in which a surface of the initial planarization layer away from the base is approximately flat. The exposure refers to using an exposure machine to allow laser light to pass through the mask 2000 to illuminate the initial planarization layer, so that some regions of the initial planarization layer are subjected to illumination treatment. The development is to spray a developing solution on the initial planarization layer after the exposure, in which an illuminated portion of the initial planarization layer is dissolved in the developing solution to a different extent than a non-illuminated portion of the initial planarization layer is dissolved in the developing solution, thereby removing some regions of the initial planarization layer and exposing some regions of the initial planarization layer to form the planarization layer. In the embodiments of the present disclosure, the description is taken as an example in which the illuminated portion of the planarization layer is capable of being removed during the development process. Here, according to the difference in the extent of illumination in the initial planarization layer, patterns with different depths, such as the trench, the first recessed portions, the second recessed portions, and the through holes, can be formed in the initial planarization layer.

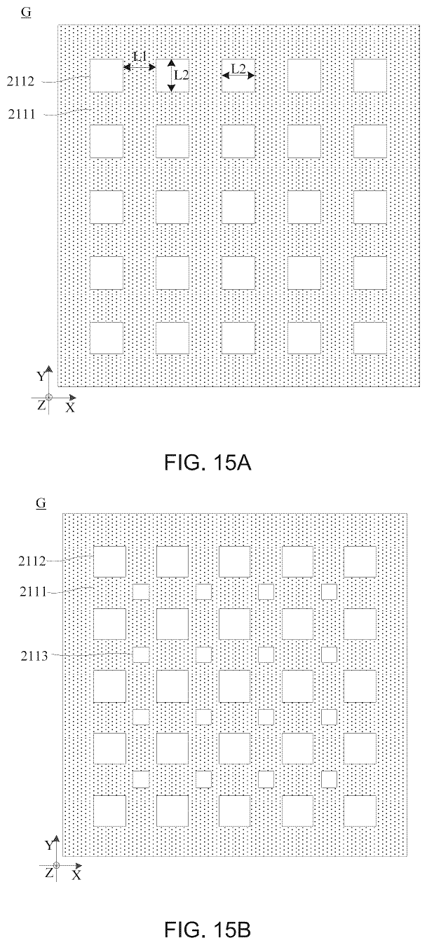

Referring to FIG. 14, the mask 2000 provided by the embodiments of the present disclosure includes a second pattern region 2100. The second pattern region 2100 may, for example, correspond to the first pattern region of the planarization layer and be used to cause the planarization layer to form a portion in the first pattern region. The second pattern region 2100 includes a plurality of first opening regions 2110, and each first opening region 2110 is configured to cause the planarization layer to form a first recessed portion. Referring to FIG. 15A, the first opening region 2110 includes a first light-shielding pattern 2111 and multiple first through holes 2112 spaced apart, and a boundary of the first light-shielding pattern 2111 defines the multiple first through holes 2112. A light transmittance of the first light-shielding pattern 2111 is 0%, and light transmittances of the first through holes each are 100%. Here, a distance L1 between two adjacent first through holes 2112 is less than or equal to a first threshold M, and a maximum size L2 of each first through hole 2112 is less than or equal to the first threshold M. The first threshold M is ½ of a resolution of an exposure machine as used.

It can be understood that the opening of the first through hole 2112 is generally in a regular shape, which is beneficial to reducing the processing difficulty of the mask 2000 and reducing the cost of the mask 2000. The maximum size L2 of the first through hole 2112 refers to the diameter or side length of the first through hole 2112. For example, in a case where the opening (a boundary shape) of the first through hole 2112 is in the shape of a rectangle, the maximum size of the first through hole 2112 is the side length of the first through hole 2112; and in a case where the opening of the first through hole 2112 is in the shape of circular, the maximum size of the first through hole 2112 is the diameter of the first through hole 2112.

In a case where the maximum size L2 of the first through hole 2112 is greater than the resolution of the exposure machine, the light (exposure energy) can completely pass through the first through hole 2112 and reach the glass substrate, thereby fully acting on the initial planarization layer, and finally the through holes are formed on the initial planarization layer. In a case where the opening of the first through hole 2112 is less than the resolution of the exposure machine (for example, less than ½ of the resolution of the exposure machine), the exposure energy will mainly rely on diffraction to pass through the first through hole 2112, in this way, the exposure energy can only partially pass through the first through hole 2112, which can only function at a certain depth on the surface of the initial planarization layer, and finally forms a groove of a certain depth on the initial planarization layer. Based on this, the same effect as the half-tone mask can be achieved.

In the embodiments of the present disclosure, the distance L1 between two adjacent first through holes 2112 and the maximum size of each first through hole 2112 are both less than or equal to the first threshold M. In this way, the first opening region 2110 can form an effect similar to a half-tone mask. The maximum size L2 of the first through hole 2112 is less than or equal to the first threshold, which can prevent light from directly passing through the first through hole 2112 and illuminating the initial planarization layer, so that the light mainly relies on diffraction to pass through the first through hole 2112. The distance L1 between two adjacent first through holes 2112 is less than or equal to the first threshold, which can prevent the distance between the two first through holes 2112 from being too large, causing formation of a problem of the unevenness on the first bottom wall of the first recessed portion. In this way, it is beneficial to improve the flatness of the first bottom wall of the formed first recessed portion.

In some embodiments, illumination energy through the first opening region 2110 can be controlled by controlling the area of the first opening region 2110, the area ratio of the first through holes 2112 in the first opening region 2110, and the area size of each first through hole 2112, thereby controlling the depth of the first recessed portion formed. Based on this, different opening regions 2110 can be set in different regions of the mask, thereby forming patterns with different areas and depths in the planarization layer.

Moreover, since the light transmittance of the first through hole 2112 is 100%, there is no region of light transmission gradient between the first through hole 2112 and the connecting pattern 2111, and between the first through hole 2112 and a region surrounding the first opening region 2110. Therefore, the variation of the slope of the tangent line of the side wall of the first recessed portion formed in the planarization layer by using the first opening region 2110 can be less than 0.1, that is to say, the side wall of the first recessed portion can be a straight slope. Please refer to the above, in this way, it is beneficial to improve the blocking effect of the first recessed portion on the alignment liquid and reduce the overflow distance of the alignment liquid.

In some embodiments, referring to FIG. 15A, the multiple first through holes 2112 included in each first opening region 2110 are arranged in multiple rows and multiple columns. That is to say, the multiple first through holes 2112 are evenly arranged. Each column includes multiple first through holes 2112 spaced apart along the second direction Y; and each row includes multiple first through holes spaced apart along the first direction X. The second direction Y and the first direction X intersect with each other, for example, the first direction X and the second direction Y are perpendicular.

For example, a distance between two adjacent first through holes 2112 in each row is the same, a distance between two adjacent first through holes 2112 in each column is the same, and the distance between two adjacent first through holes 2112 in each row is equal to the distance between two adjacent first through holes 2112 in each column. In this way, it is beneficial to improve the uniformity of illumination at different positions on the initial planarization layer corresponding to the first opening region 2110, thereby improving the flatness of the first bottom wall of the formed first recessed portion.

In some embodiments, when a deeper groove needs to be formed, referring to FIG. 15B, a second through hole 2113 can also be provided between four first through holes 2112 in every two adjacent rows and every two adjacent columns. The size of the second through hole 2113 is less than the size of the first through hole 2112. The second through hole 2113 can increase the amount of illumination passing through the first opening region 2110, thereby increasing the depth of the finally formed first recessed portion. For example, in a case where the planarization layer includes both the first recessed portion and the second recessed portion, the first recessed portion can be formed by using the first opening region as shown in FIG. 15A, and the second recessed portion can be formed by using the first opening region as shown in FIG. 15B.

Alternatively, the purpose of increasing the depth of the second recessed portion can also be achieved by increasing the area of the first opening region 2110. For example, the mask 2000 can further have second opening regions, the first opening regions each are used to form a first recessed portion, and the second opening regions each are used to form a second recessed portion. The area of the second opening region is greater than the area of the first opening region; alternatively, the second opening region includes multiple third through holes, and the area ratio of the third through holes in the second opening region is greater than the area ratio of the first through holes (and the second through holes) in the first opening region.

In some embodiments, referring to FIGS. 14 and 15A, the shape of the first opening region 2110 is a rectangle, such as a rectangle or a square. In the drawings of this application, taking the shape of the first opening region 2110 as a square as an example for exhibition. The side length L4 of the first opening region 2110 is greater than or equal to 10 μm, which can increase the quantity of first through holes 2112 (and second through holes) in the first opening region 2110, resulting in an overall effect similar to semi transmittance in the first opening region 2110. For example, the side length L4 of the first opening region 2110 may be any numerical value greater than or equal to 10 μm, such as 10 μm, 15 μm, 18.5 μm, or 22 μm, which will not be listed one by one in the embodiments of the present disclosure.

A distance L5 between two adjacent first opening regions 2110 is greater than or equal to 5 μm. In this way, a connecting pattern of a certain width can be formed between two adjacent first recessed portions in the planarization layer to ensure that there is a certain gap between the two adjacent first recessed portions. For example, the distance L5 between two adjacent first opening regions 2110 may be 5 μm, 8 μm, 9.5 μm, or the like, which will not be listed one by one in the embodiments of the present disclosure.

As shown in FIG. 15A, in each first opening region 2110, a distance L1 between two adjacent first through holes 2112 is in a range of 1.0 μm to 1.5 μm, inclusive. In this way, it is beneficial to form a flat first bottom wall at the bottom of the first recessed portion. For example, the distance L1 between two adjacent first through holes is 1.0 μm, 1.3 μm, or 1.5 μm, which will not be listed one by one in the embodiments of the present disclosure.

In some embodiments, the opening shape of the first through hole 2112 (the shape enclosed by the boundary) is a square, and the side length of the first through hole 2112 is in a range of 1.0 μm to 1.5 μm, inclusive. If the side length of the first through hole 2112 is less than 1.0 μm, it will significantly increase the difficulty of preparing the first through hole 2112, thereby increasing the preparation cost of the mask 2000. If the side length of the first through hole 2112 is greater than 1.5 μm, it will lead to more light passing through the first through hole 2112 and is prone to form an uneven first bottom wall at the bottom of the first recessed portion. Based on the above reasons, in the embodiments of the present disclosure, the side length of the first through hole 2112 is in the range of 1.0 μm to 1.5 μm, inclusive. For example, the side length of the first through hole 2112 may be 1.0 μm, 1.25 μm, or 1.5 μm, which will not be listed one by one in the embodiments of the present disclosure.

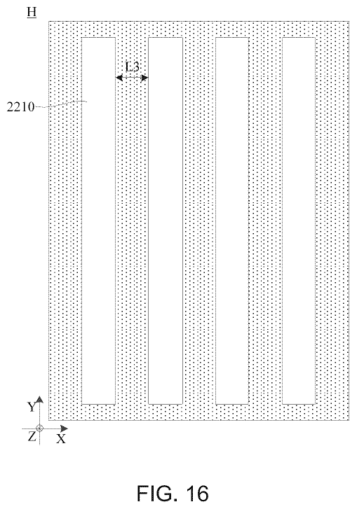

In some embodiments, as shown in FIG. 14, the mask 2000 further includes a third pattern region 2200, and the third pattern region 2200 is configured to form the trench of the array substrate (of the planarization layer). As shown in FIG. 16, the third pattern region 2200 may include multiple third through holes 2210 spaced apart along the first direction X. Along the second direction Y, a dimension of the third through hole 2210 is greater than a dimension of the first through hole 2112. In this way, a dimension of the formed trench along the second direction X is greater than a dimension of the first recessed portion along the second direction. A distance L3 between two adjacent third through holes 2210 along the first direction X is less than or equal to the first threshold M, which is beneficial to improving the flatness of the second bottom wall of the formed trench.

In some embodiments, as shown in FIG. 16, in a case where the mask 2000 includes a third pattern region 2200 and the third pattern region 2200 includes multiple third through holes 2210, a distance between two adjacent third through holes 2210 can also be in a range of 1.0 μm to 1.5 μm, inclusive. In this way, it is beneficial to reduce the preparation cost of the mask 2000 and form a flat second bottom wall at the bottom of the trench, simultaneously. For example, the distance between two adjacent third through holes 2210 may be 1.0 μm, 1.35 μm, or 1.5 μm, which will not be listed one by one in the embodiments of the present disclosure.

For example, the opening shape of the third through hole 2210 may be an oblong, each third through hole 2210 extends along the second direction Y, and the multiple third through holes 2210 are spaced apart along the first direction X.

The foregoing description is only specific embodiments of the present disclosure, but the scope of protection of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. An array substrate having a display region, a fan-out region, and a bonding region, and comprising:
a base;
a plurality of connecting leads provided on a side of the base and located in the fan-out region; and
a planarization layer located on a side of the plurality of connecting leads away from the base, and having a first pattern region located in the fan-out region, wherein the planarization layer includes a plurality of first recessed portions provided in the first pattern region, and an orthographic projection of at least one first recessed portion on the base overlaps with an orthographic projection of at least one connecting lead on the base; and along a direction perpendicular to the base, the first recessed portions and the connecting leads have a distance therebetween.

2. The array substrate according to claim 1, wherein a ratio of a depth, along the direction perpendicular to the base, of the first recessed portion to a thickness, along the direction perpendicular to the base, of the planarization layer is in a range of 0.25 to 0.65, inclusive.

3. The array substrate according to claim 1, wherein
the first recessed portion includes a first bottom wall, and the first bottom wall is proximate to the base; and along the direction perpendicular to the base, a distance between the first bottom wall and the connecting lead is greater than or equal to 1 μm.

4. The array substrate according to claim 3, wherein the first recessed portion further includes a first side wall, and a slope of a tangent line of the first side wall has a variation less than or equal to 0.1.

5. The array substrate according to claim 4, wherein the planarization layer further includes a connecting portion provided in the first pattern region, and the connecting portion is located between the plurality of first recessed portions and connects the plurality of first recessed portions; and
an included angle between a surface of the connecting portion away from the base and the first side wall is in a range of 125° to 160°, inclusive.

6. The array substrate according to claim 5, wherein the included angle between the surface of the connecting portion away from the base and the first side wall is in a range of 150° to 155°, inclusive.

7. The array substrate according to claim 1, further comprising:
a plurality of bonding pins provided in the bonding region, each bonding pin being electrically connected to at least one connecting lead;
wherein along a first direction, a distance between outer boundaries of two first recessed portions furthest away from each other is greater than a distance between outer boundaries of two bonding pins furthest away from each other in the bonding region; and the first direction is parallel to an extension direction of a boundary between the display region and the fan-out region.

8. The array substrate according to claim 1, wherein the plurality of first recessed portions are arranged in multiple rows, and the multiple rows of first recessed portions are spaced apart along a second direction; any two adjacent rows of first recessed portions are staggered along a first direction; and the first direction is parallel to an extension direction of a boundary between the display region and the fan-out region, and the second direction is parallel to an arrangement direction of the display region and the fan-out region.

9. The array substrate according to claim 1, wherein the planarization layer further includes a trench, and the trench is located in the fan-out region and is further away from the display region than the first pattern region; the array substrate further has a first side edge and a second side edge that are opposite in a first direction, the first direction is parallel to an extension direction of a boundary between the display region and the fan-out region, and the trench extends from the first side edge to the second side edge.

10. The array substrate according to claim 9, wherein an orthographic projection of the trench on the base partially overlaps with an orthographic projection of at least one connecting lead on the base; and
a ratio of a depth, along the direction perpendicular to the base, of the trench to a thickness, along the direction perpendicular to the base, of the planarization layer is in a range of 0.25 to 0.65, inclusive.

11. The array substrate according to claim 9, wherein the trench includes a second bottom wall; and a distance, along the direction perpendicular to the base, between the second bottom wall and the connecting lead is greater than or equal to 1 μm.

12. The array substrate according to claim 9, wherein a depth, along the direction perpendicular to the base, of the trench is greater than a depth, along the direction perpendicular to the base, of the first recessed portion.

13. The array substrate according to claim 9, wherein
a boundary of the first pattern region proximate to the bonding region is a polyline; and
the trench extends along an extension direction of the boundary of the first pattern region proximate to the boning region.

14. The array substrate according to claim 9, wherein
a distance between the first pattern region and the display region is in a range of 100 μm to 200 μm, inclusive; and/or
a distance between the first pattern region and the trench is in a range of 5 μm to 50 μm, inclusive; and/or
a distance between the trench and the bonding region is in a range of 5 μm to 50 μm, inclusive.

15. The array substrate according to claim 1, wherein the fan-out region includes a first wiring region; a width, in the first wiring region, of the connecting lead is in a range of 1.5 μm to 1.9 μm inclusive; a distance between two adjacent connecting leads is in a range of 1.6 μm to 2.0 μm, inclusive; and the orthographic projection of the first recessed portion on the base overlaps with orthographic projections of at least two connecting leads on the base.

16. The array substrate according to claim 1, wherein the planarization layer further includes a plurality of second recessed portions provided in the first pattern region, and orthographic projections of the second recessed portions on the base are non-overlapping with orthographic projections of the connecting leads on the base; and a depth of a second recessed portion is greater than a depth of the first recessed portion.

17. The array substrate according to claim 1, wherein a distance between a boundary of the display region proximate to the bonding region and a boundary of the bonding region away from the display region is less than or equal to 2.4 mm.

18. (canceled)

19. A display panel, comprising:
the array substrate according to claim 1;
a color filter substrate provided opposite the array substrate; and
a liquid crystal layer provided between the array substrate and the color filter substrate.

20. A display device, comprising:
the display panel according to claim 19;
wherein the display device further comprises:
a flexible circuit board and a driver chip, wherein
the flexible circuit board is bonded to the array substrate of the display panel, and at least partially bent to a back side of the array substrate; and
the driver chip is provided on the array substrate, and located between the flexible circuit board and a trench of the array substrate;
or
a chip-on-film and a driver chip, wherein
the chip-on-film is bonded to the array substrate of the display panel, and at least partially bent to a back side of the array substrate; and
the driver chip is provided on the chip-on-film, and located on the back side of the array substrate.

21. (canceled)

22. A mask for manufacturing the array substrate according to claim 1, the mask comprising:
a second pattern region including a plurality of first opening regions, each first opening region being configured to cause the planarization layer to form a first recessed portion, wherein the first opening region includes a first light-shielding pattern and multiple first through holes spaced apart, and a boundary of the first light-shielding pattern defines the multiple first through holes; and a light transmittance of the first light-shielding pattern is 0%, and light transmittances of the first through holes are 100%,
wherein
a shape of each first opening region is a rectangle, and a side length of the first opening region is greater than or equal to 10 μm; and/or
a distance between two adjacent first opening regions is greater than or equal to 5 μm; and/or
a distance between two adjacent first through holes in each first opening region is in a range of 1.0 μm to 1.5 μm, inclusive; and/or
an opening shape of each first through hole is a square, and a side length of the first through hole is in a range of 1.0 μm to 1.5 μm, inclusive.

23. (canceled)
